(19) United States
(12) Patent Application Publication
(10) Pub. No.: US 2010/0302513 A1
(43) Pub. Date: Dec. 2, 2010

(54) PROJECTION-TYPE IMAGE DISPLAYING APPARATUS

(76) Inventors: YOSHITAKA TAKAHASHI, Noda-shi (JP); Hiroshi Akiyama, Yokohama-shi (JP)

Correspondence Address: DICKSTEIN SHAPIRO LLP, 1825 EYE STREET NW, Washington, DC, 20006-5403, US

(21) Appl. No.: 12/790,150

(22) Filed: May 28, 2010

(30) Foreign Application Priority Data
May 29, 2009 (JP) 2009-129736
Mar. 25, 2010 (JP) 2010-069060

(51) Int. Cl. G03B 21/14

(52) U.S. Cl. 353/33; 353/31

(57) ABSTRACT

A projection-type image display apparatus for displaying an image on a projected plane, includes light sources each configured to emit a light, a light-path combining element configured to combine light paths of the lights each emitted from the light sources, a light path splitting element configured to split the lights on the combined light path into first and second lights, a scanning mirror configured to reflect the first lights to scan the projected plane with the first lights, a light receiving element configured to receive the second lights to detect light amounts of the received second lights, and a control circuit configured to control the scanning mirror to scan an image forming area of the projected plane with the first lights based on image data and control the light sources so as to reproduce a color based on the image data. The control circuit is configured to control the light receiving element to detect the light amounts of the light sources when the image forming area is scanned with the first light, and adjust emitting light amounts of the light sources based on the detected light amounts of the light sources.

### CROSS REFERENCE TO RELATED APPLICATIONS

The present application is based on and claims priority from Japanese Application Numbers 2009-129736, filed on May 29, 2009 and 2010.69060, filed on Mar. 25, 2010, the disclosure of which is hereby incorporated by reference herein in its entirety.

### BACKGROUND OF THE INVENTION

1. Field of the Invention

The present invention relates to a projection-type image displaying apparatus configured to form an image with scanning lights modulated by and emitted from a plurality of laser light sources.

2. Description of the Related Art

Recently, in order to achieve small size and easily portable apparatus, a projection-type image displaying apparatus (also, referred to as a projector) configured to form an image with scanning lights modulated by and emitted from a plurality of laser light sources or LED light sources has been developed.

Particularly, a scanning-type small size projector configured by combining three primary color laser light sources and a MEMS (micro electro mechanical system) mirror has been actively developed from a view point of possibility of a small number of components and microminiaturization (see, for example, Japanese Patent No. 4031481).

A conventional optical system of such a scanning type projector having three primary color laser light sources and a MEMS mirror is shown in FIG. 15.

In FIG. 15, 1R, 1G and 1B indicate semiconductor lasers emitting laser lights of R (red), G (green) and B (blue) as the three primary color laser light sources, respectively. The laser lights modulated by and emitted from the semiconductor lasers 1R, 1G and 1B are condensed by condensing lenses 2R, 2G and 2B and guided to dichroic mirrors 3R, 3G and 3B, respectively.

The dichroic mirror 3R totally reflects a red light, the dichroic mirror 3G totally reflects a green light and transmits the other color lights, and the dichroic mirror 3B totally reflects a blue light and transmits the other color lights.

The red light is reflected on the dichroic mirror 3R, transmits the dichroic mirrors 3G, 3B and is guided to the MEMS mirror (Micro Electra Mechanical Systems) device 4. The green light is reflected on the dichroic mirror 3G, transmits the dichroic mirror 3B and is guided to the MEMS mirror device 4. The blue light is reflected on the dichroic mirror SB and is guided to the MEMS mirror device 4.

The MEMS mirror device 4 has, as shown in FIG. 16, a structure in that a rectangular internal frame 7 is supported via a pair of torsion bars 6 on a rectangular external frame 5 and a micro mirror 8 is supported via a pair of torsion bars 9 on the internal frame 7.

The pair of torsion bars 6 form an oscillating axis 10 and the pair of torsion bars 9 form an oscillating axis 11, the oscillating axes being perpendicular to each other.

The micro mirror 8 is reciprocately turned in α directions about the oscillating axis 10 by providing a torsional power on the pair of torsion bars 6, and is reciprocately turned in β directions about the oscillating axis 11 by providing a torsional power on the pair of torsion bars 9. A normal line of a reflection surface of the micro mirror 8 is two-dimensionally displaced by adding the torsional powers to the torsion bars 6, 9. As a result, the reflecting direction of the laser light entering the micro mirror 8 is changed and the laser light is used for performing a two-dimensionally scanning with the laser light.

The semiconductor lasers 1R, 1G and 1B and the MEMS mirror device 4 are controlled by a control circuit 12. An original image data (input video signal) VIN is input to the control circuit 12. The control circuit 12 has a light intensity modulating device and a mirror control device. The light intensity modulating device is configured to modulate light intensities of the semiconductor lasers 1R, 1G and 1B based on R, G and B data of the original image data, respectively to perform a light amount control if each of the plurality of semiconductor lasers. The mirror control device is configured to control an inclined angle of the micro mirror 8 of the MEMS mirror device 4 based on projection position data of the original image data to perform a angle control of the micro mirror 8.

By performing the light amount control of the semiconductor lasers 1R, 1G and 1B and the angle control of the micro mirror 8 by use of the control circuit 12, a color image is formed on a screen S.

However, current-light output property (I-L property) of the semiconductor laser varies due to temperature change, as shown in FIG. 17. In the semiconductor laser, with increase of temperature, a driving current value which is a current value at a point when a laser oscillation starts is increased.

For example, if the light output at the temperature of 25° C. and at the driving current of I₀ is P₁, the light output is decreased to P₂ and then P₃ with increase of the temperature to 50° C. and then 80° C.

An internal temperature of the projector is increased upon turning on the power until it reaches equilibrium state. The decreases of the light outputs vary from the semiconductor lasers 1R, 1G and 1B. Thereby, color balance on the screen S is degraded so that a faithful color reproduction of the original image cannot be achieved.

Then, in the conventional projector technology, while monitoring the emitting light intensities of the semiconductor lasers 1R, 1G and 1B, driving current values are controlled so as to obtain desired light outputs (see Japanese Patent Application Publication Nos. 2006-317681 and 2003-5110).

“Auto Power Control” (hereinafter, referred to as APC) means monitoring a light output of the light source and controlling a driving current so as to keep the light output of the light source constant.

However, in the projector disclosed in Japanese Patent Application Publication No. 2006-317681, as shown in FIG. 18, the APC is performed in a non-image forming area G2 which is an area other than the image forming area G1 on the screen S. In FIG. 18, a solid line RL is a scanning line where an image is formed on the screen S and a dashed line BL is a scanning line where an image is not formed on the screen S.

At parts (BLg, BLb, BLr) on the scanning line BL where the image is not formed, the APC controls of the semiconductor lasers 1R, 1G and 1B of red, green and blue are performed. The solid line RK shows a return trace (comeback line) of the scanning line.

As described above, in the projector disclosed in Patent Application Publication No. 2006-317681, the APC is performed at the non-image forming area G2 which does not contribute to image formation. Accordingly, since the image forming area G1 is not scanned with the scanning light while the non-image forming area G2 is scanned, the image formed on the screen S appears as a dark image.

Furthermore, as disclosed in Japanese Patent Application Publication Nos. 2006-317681 and 2003-5110, a shielding member is necessary to prevent the light from being not projected on the non-image forming area G2 of the screen S when the APC is performed, and also it is required to assemble the shielding member in an accurate relative positional relationship between the shielding member and light fluxes as well as extra components being required. This becomes a factor for cost-up.

In addition, a wavelength of the light source such as a semiconductor laser varies due to temperature and therefore if a light flux splitting optical system formed of a multilayer film is configured as a light flux splitting element, according to the property of the multilayer film, there is a problem in that there is a possibility in that the light amount of the split light flux is changed according to variation in the wavelength due to temperature so that stable control cannot be performed.

### SUMMARY OF THE INVENTION

An object of the present invention is to provide an image displaying apparatus in which an APC is performed to suppress color change of an image due to change in a light source output, the APC being performed in an image forming area to allow an area which is to be scanned with a light flux to be close to the image forming area as much as possible and to improve brightness of the image. At this time, it is also aimed to avoid increase of a number of components and cost-up due to the increase of the number of components.

Furthermore, it is aimed to reduce difference in control signal levels due to difference in sensitivities of a light receiving element for lights of a plurality of wavelengths and to achieve the APC of the plurality of light sources with a simple control circuit.

A projection-type image display apparatus for displaying an image on a projected plane, according to an embodiment of the present invention, includes a plurality of laser light sources each configured to emit a laser light, a light-path combining element configured to combine light paths of the laser lights each emitted from the plurality of laser light sources, a light path splitting element configured to split the combined light path into first and second light paths, each of the laser lights being split into a first light passing the first light path and a second light passing the second light path, a scanning mirror configured to reflect the first lights of the laser lights to scan the projected plane with the first lights of the laser lights, a light receiving element configured to receive the second lights of the laser lights to detect light amounts of the received second lights, and a control circuit configured to control the scanning mirror to scan an image forming area of the projected plane with the first lights of the laser lights based on image data and control the plurality of laser light sources so as to reproduce a color based on the image data. The control circuit is configured to control the light receiving element to detect the light amounts of the plurality of laser light sources when the image forming area is scanned with the first light, and adjust emitting light amounts of the plurality of laser light sources based on the detected light amounts of the plurality of laser light sources.

### BRIEF DESCRIPTION OF THE DRAWINGS

FIG. 1 is a view showing an optical system of a projection-type image displaying apparatus according to an embodiment 1 of the present invention.

FIG. 2 is an explanatory view of an image forming area formed on a screen shown in FIG. 1

FIG. 3 is a partially-enlarged view of a vicinity of a coordinate point J shown in FIG. 2.

FIG. 4 is a flowchart of a light amount setting method of light sources.

FIG. 5 is a partially-enlarged view showing a modified example of an optical system shown in FIG. 1.

FIG. 6 is a timing chart showing a relationship between a light emitting timing and emitting light intensity of each laser light source of a project-type image displaying apparatus according to an embodiment 2 of the present invention.

FIG. 7 is a view of characteristic curve showing a photoelectric conversion efficiency to wavelength in a light receiving element shown in FIG. 1.

FIG. 8 is a timing chart showing a relationship between a light emitting timing and emitting light intensity of each laser light source of the projection-type image displaying apparatus according to an embodiment 3 of the present invention.

FIG. 9 is a partially enlarged view showing a part of an optical system of a projection type image displaying apparatus according to an embodiment 4 of the present invention.

FIG. 10A is a partially enlarged view showing a part of another optical system of the projection-type image displaying apparatus according to the embodiment 4 of the present invention.

FIG. 10B is a view showing a beam spot of each laser light, which is formed by a wedge optical element shown in FIG. 10A on the light receiving element

FIG. 11 is a timing chart showing a relationship between light emitting timing and emitting light intensity of each laser light source of a projection-type image displaying apparatus according to an embodiment 5 of the present invention.

FIG. 12 is a timing chart showing relationship between light emitting timing and emitting light intensity of each laser light source of a projection-type image displaying apparatus according to an embodiment 6 of the present invention.

FIG. 13 is a timing chart showing another relationship between a light emitting timing and an emitting light intensity of the projection image displaying apparatus according to the embodiment 6 of the present invention.

FIG. 14 is a partially enlarged view showing a modified example of the optical system.

FIG. 15 is a view showing an example of an optical system of the conventional projection-type image displaying apparatus.

FIG. 16 is an explanatory view showing an example of a configuration of a mirror shown in FIG. 15.

FIG. 17 is a characteristic view showing a relationship between a temperature of a semiconductor laser light source shown in FIG. 15 and an light output.

FIG. 18 is a view for explaining an example of the conventional APC control.

### DETAILED DESCRIPTION OF THE PREFERRED EMBODIMENTS

Preferred embodiments of the present invention will be explained in detail with reference to the accompanying drawings below.

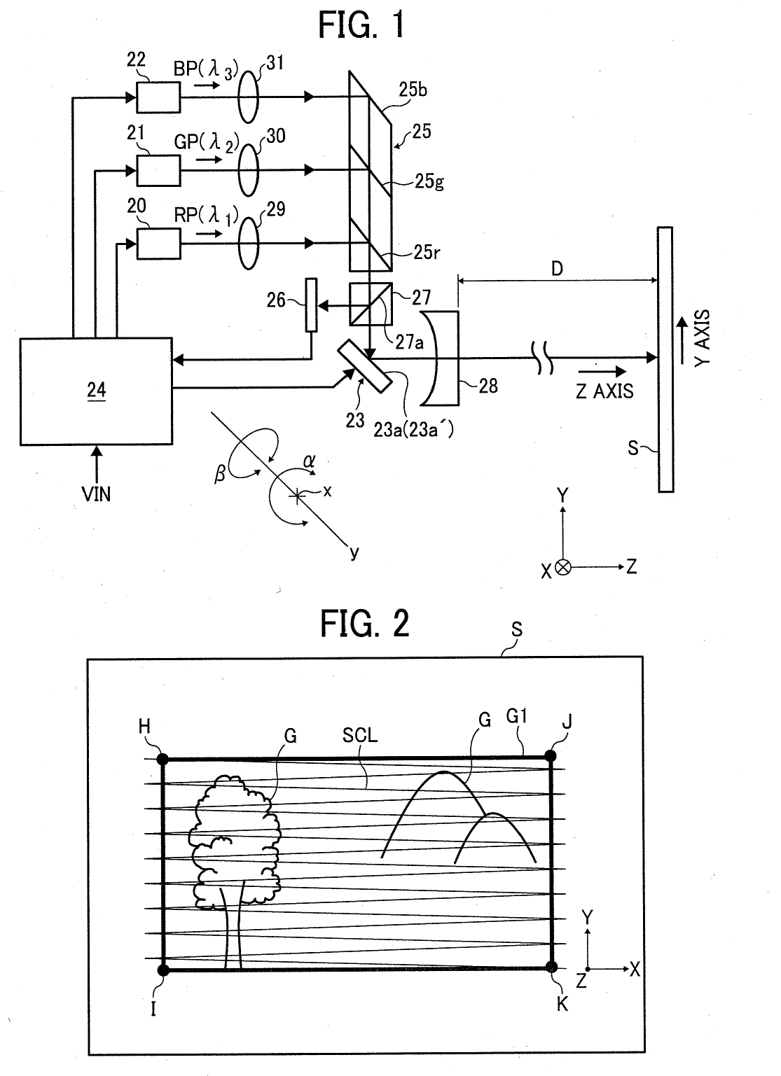

As shown in FIG. 1, for example, projection-type image display apparatus according to an embodiment of the present invention, which is used for displaying an image on a projected plane, include a plurality of light sources such as a plurality of laser light sources 20 to 22 each configured to emit, for example, a laser light RP, GP or BP, a light-path combining element such as a light path combining prism 25 configured to combine light paths of the laser lights RP, GP and BP each emitted from the plurality of laser light sources, a light path splitting element or a light flux splitting element configured to split the combined light path into first and second light paths, each of the laser lights RP, GP and BP being split into a first light passing the first light path and a second light passing the second light path, a scanning mirror such as a MEMS mirror 23 configured to reflect the first lights of the laser lights RP, GP and BP to scan the projected plane with the first lights of the laser lights, a light receiving element 26 configured to receive the second lights of the laser lights to detect light amounts of the received second lights, and a control circuit 24 configured to control the scanning mirror 23 to scan an image forming area of the projected plane with the first lights of the laser lights based on image data VIN and control the plurality of laser light sources 20 to 22 so as to reproduce a color based on the image data VIN. The control circuit 24 is configured to control the light receiving element 26 to detect the light amounts of the plurality of laser light sources when the image forming area is scanned with the first lights, and adjust emitting light amounts of the plurality of laser light sources 20 to 22 based on the detected emitting light amounts of the plurality of laser light sources 20 to 22.

### EMBODIMENT 1

FIG. 1 is a view showing an optical system of a projection-type image display apparatus according to an embodiment of the present invention.

In FIG. 1, reference number 20 indicates a laser light source configured to emit a red laser light RP (wavelength λ1) as a diverging light, 21 indicates a laser light source configured to emit a green laser light GP (wavelength λ2) as a diverging light, 22 indicates a laser light source configured to emit a blue laser light BP (wavelength λ3) as a diverging light, 23 indicates a MEMS mirror device, 24 indicates a control circuit, 25 indicates a light-path combining prism, 26 indicates a light receiving element for monitoring a light amount (referred to as “light receiving element” or “monitoring light receiving element”), 27 indicates a light-path splitting prism, and 28 indicates a concave lens as a projection lens.

Original image data (R, G, B data of input video signals, projection position data, and the like) VIN are input to the control circuit 24. The control circuit 24 has a light intensity modulation device and a mirror control device. The light intensity modulation device is configured to modulate light intensities of the laser light sources 20, 21, and 22 based on the R, G, B data of the original image data. The mirror control device is configured to control an inclined angle of a micro mirror 23a of the MEMS mirror device 23 based on the projection position data of the original image data.

The light-path combining prism 25 performs a function of combining the light paths of the laser lights RP, GP, and BP into one light path. The light-path combining prism 25 has a total reflecting surface 25b and cemented surfaces 25g, 25r. On the cemented surface 25r, a dichroic film configured to reflect the red laser light RP (wavelength λ1) and transmit the green laser light GP (wavelength λ2) and the blue laser light BP (wavelength λ3) is formed. On the cemented surface 25g, a dichroic film configured to reflect the green laser light GP (wavelength λ2) and transmit the blue laser light BP (wavelength λ3) is formed.

The laser light RP emitted from the laser light source 20 is converted into a converging light by a coupling lens 29 and guided to the light-path combining prism 25. The converging light is reflected on the cemented surface 25r of the light-path combining prism 25 and guided to the light-path splitting prism 27.

The laser light GP emitted from the laser light source 21 is converted into a converging light by a coupling lens 30 and guided to the light-path combining prism 25. The converging light is reflected on the cemented surface 25g of the light-path combining prism 25, transmitted through the cemented surface 25r and guided to the light-path splitting prism 27.

The laser light BP emitted from the laser light source 22 is converted into a converging light by a coupling lens 31 and guided to the light-path combining prism 25. The converging light is reflected on the total reflecting surface 25b of the light-path combining prism 25, transmitted through the cemented surfaces 25g, 25r and guided to the light-path splitting prism 27.

The light-path splitting prism 27 is configured to split the combined light path into first and second light paths and splits each of the laser lights RP, GP and BP into a first light passing the first light path and a second light passing the second light path. That is, the light-path splitting prism 27 splits the laser lights RP, GP and BP in two directions. One split light of a main part of each of the laser lights RP, GP and BP as the first light is transmitted through the light-path splitting prism 27 and another split light of the other part of each of the laser lights RP, GP and BP as the second light is reflected toward the light receiving element 26.

As the light-path splitting prism 27, glass or plastic flat plate may be used as described in detail below.

Each of the laser lights RP, GP and BP transmitted through the light-path splitting prism 27 is guided to a reflecting surface 23a′. The laser lights RP, GP and BP are reflected on the reflecting surface 23a′, respectively, and guided to a concave lens 28. The concave lens 28 performs a function of converting each of the laser lights RP, GP and BP as the converging lights into substantially parallel lights, respectively. Each of the laser lights RP, GP and BP is transmitted through the concave lens 28 and then guided to a screen S as a projected plane disposed at a predetermined distance D from the concave lens 28.

Here, if the laser lights RP, GP and BP are converted into the substantially-parallel lights by the coupling lenses 29, 30 and 31, respectively, the concave lens 28 may be dispensed with.

The micro mirror 23a is turned about mutually-perpendicular x and y axes as centers. In FIG. 1, the x axis is indicated as an axis orthogonal to the drawing plane and the y axis is indicated as an axis inclined at 45 degrees to ZY axes in the drawing plane (ZY plane). In FIG. 1, the Z axis is indicated as an axis orthogonal to the screen S, the X axis (a vertical axis in the screen S) is indicated as an axis parallel to the x axis, and the Y axis (a horizontal axis in the screen S) is indicated as an axis orthogonal to the X and Z axes.

The micro mirror 23a is turned in α directions about the x axis and turned in β directions about the y axis so that a reflecting direction of each laser light RP, GP and BP varies. The control circuit 24 controls the inclined angle of the micro mirror 23a based on the original image data VIN as well as modulating the light intensities of the laser light sources 20, 21, and 22. Thereby, the screen is scanned so that a two-dimensional image is formed on the screen S.

An output of the light-receiving element 26 is input to the control circuit 24. The control circuit 24 controls emitting light intensities of the laser light sources 20, 21 and 22 so as to be increased and decreased based on the output of the light-receiving element 26.

FIG. 2 is an explanatory view showing a formed state of an image G on the screen S. In FIG. 2, an image forming area G1 is shown by a thick line frame. “SCL” indicates scanning lines.

The emitting light intensities are modulated from a coordinate point II of the image forming area G1 of the screen S corresponding to the R, G and B data of the original image and the scanning is started based on the projection position data of the original image. The screen S is scanned from the coordinate point H to a coordinate point K in a zig-zag manner and thereby one image G is formed on the screen S.

Then, the screen S is scanned in an opposite direction from the coordinate point K to the coordinate point H in a zig-zag manner corresponding to the original image data so that one image G is formed on the screen S.

By repeating these scanning more than once, the image G is displayed on the screen S without flickers.

Here, the scanning of the screen S in the direction of the X axis is performed by turning the micro mirror 23a in the β directions about the y axis shown in FIG. 1 and the scanning of the screen S in the direction of the Y axis is performed by turning the micro mirror 23a in the α directions about the x axis.

Although it appears that the image forming area G1 on the screen S is not fully scanned with the scanning lines SCL shown in FIG. 2 by shifting a turning frequency in the α direction and a turning frequency in the β direction by a small amount, for example, every time scanning to form one image G, all pixels supposed in the image forming area G1 can be scanned.

Here, with reference to a coordinate point J, positions of beam spots of the laser lights RP, GP, and BP formed on the screen S, that is, on an imaging plane, are explained.

If a size of the image G is x×y=240×180 (mm) and resolution corresponds to VGA, a size of one pixel on the screen S is 0.376×0.375 (mm).

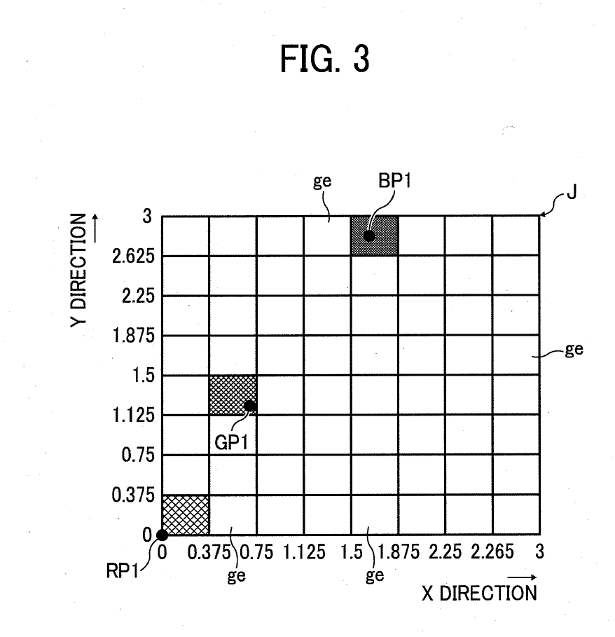

FIG. 3 shows a position RP1 where the beam spot of the red laser light RP is formed, the position RP1 being set as a coordinate origin (0, 0), a position GP1 where the beam spot of the green laser light GP is formed, and a position BP1 where the beam spot of the blue laser light BP is formed. In FIG. 3, a small area shown by a rectangular line indicates one pixel ge.

The lights RP, GP and BP entering the screen S with a small turning angle of the micro mirror 23a through a vicinity of an optical axis of the concave lens 28 enter the same one pixel ge.

However, the laser lights RP, GP and BP which enter the screen S with a large turning angle of the micro mirror 23a and reach edge parts of the image 0, for example, a vicinity of the coordinate position H or I do not enter the same one pixel, ge and enter separate positions at several or few pixels from each other.

This is because refractive index of the concave lens 28 varies depending on the wavelength of the light and the concave lens 28 has a property of chromatic aberration of magnification.

That is, trajectories of the scanning lines SCL of the laser lights RP, GP and BP are different from each other. Accordingly, as shown in FIG. 3, at the edge part of the image G, for example, at the coordinate point J, the beam spots of the laser lights RP, GP and BP are formed on different pixels ge from each other.

In addition, FIG. 3 shows, as an example, on the basis of the position RP1 where the beam spot of the laser light RP is formed, a state where the position GP1 where the beam spot of the laser light GP is formed is shifted by one pixel in the direction of the X axis and by three pixels in the direction of the Y axis and a state where the position BP1 where the beam spot of the laser light BP is formed is shifted by four pixels in the direction of the X axis and by seven pixels in the direction of the Y axis.

When the image G is displayed at the vicinity of the coordinate points H, J, I, and K, the laser light sources 20, 21 and 22 are not turned on at the same time but are turned on at timings such that the scanning lines SCL of the laser lights RP, GP and BP pass the same one pixel ge, and emit the laser lights RP, GP and BP with predetermined intensities of the laser light sources 20, 21 and 22 subsequently according to colors to be displayed.

Even when the emitting timing of the laser light sources 20, 21 and 22 are shifted, if the shift of the timings is small, three colors are combined to form a desired color to be recognized for the same one pixel ge due to afterimage effect of human eyes.

Then, at the vicinity of the coordinate points H, I, J and K as the edge parts of the image, where each of the laser light sources 20, 21 and 22 emits separately its light, the light receiving element 26 detects the emitting light amounts of the laser light sources 20, 21 and 22.

When the light amount of each of the laser lights RP, GP and BP detected by the light receiving element 26 is shifted from a predetermined light amount to be detected when each of the laser light sources 20, 21 and 22 is turned on based on the original data, the control circuit 24 controls the laser light sources 20, 21 and 22 so as to adjust and change the driving current of each of the laser light sources 20, 21 and 22 to correct the shift of the detected light amount

As a result, output variation of each of the laser light sources 20, 21 and 22 based on temperature change can be suppressed. At this time, the control circuit 24 suppresses the output variation of each of the laser light sources 20, 21 and 22 due to the temperature change based on the detected light amount of each of the laser lights RP, GP and BP, which are to form the edge parts of the image forming area G1. Accordingly, color balance can be ensured without darkening the image G formed on the screen S.

Furthermore, a relationship between the light emitting timing of the laser light source corresponding to each color and the angle of the scanning mirror is determined based on color of the image to be projected. For example, if the image at the vicinity of the coordinate point J is white, the control circuit 24 controls the laser light source 20 to emit the light at a timing of projecting the red beam spot on the pixel ge of the coordinate (0, 0) to form an image as one frame by scanning the screen from the coordinate point H to K, a time for scanning one frame being, for example, 1/60 second, the control circuit 24 controls the laser light source 21 to emit the light at a timing of projecting the green beam spot on the pixel ge of the coordinate (0, 0) after several or few frames and similarly, the control circuit 24 controls the laser light source 22 to emit the light at a timing of projecting the blue beam spot on the pixel ge of the coordinate (0, 0) after several or few frames. As described above, even if the laser light sources 20, 21 and 22 emit the lights at the timings shifted from each other, a white image is recognized by the human eye.

Furthermore, in a case where the coordinate point H shown in FIG. 2 is blue, the coordinate point I is red, and the coordinate point K is green, the control circuit may be configured to monitor light amount of each of colors at the coordinate points H, I and K.

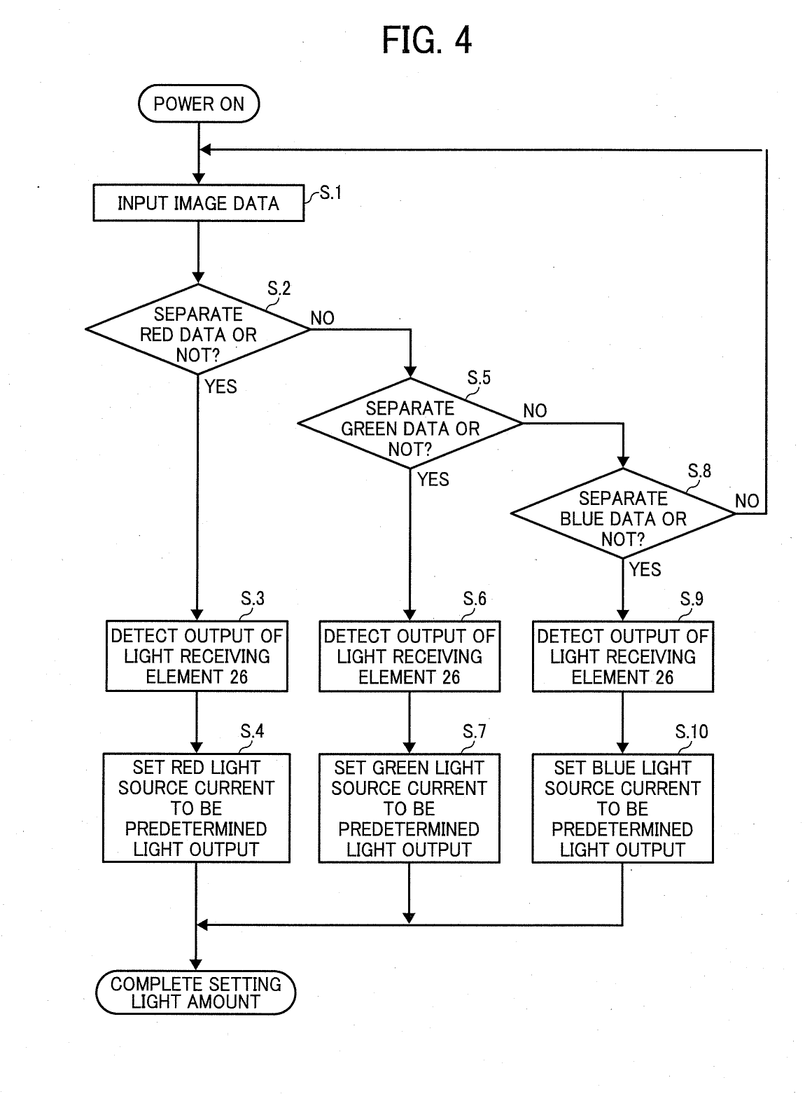

FIG. 4 is a flowchart showing a method for setting a light amount of each light source according to another embodiment of the present invention. In a case where each laser light is converted into the substantially-parallel light by each of the coupling lenses 29, 30 and 31, the concave lens 28 is not always necessary. If the concave lens 28 is not used, the above-described chromatic aberration of magnification does not occur and therefore color shift does not occur at any position of pixel Ge.

The control circuit 24 may be configured to control the light receiving element 26 to receive the second lights sequentially at timings when only one of the plurality of laser light sources emits the light based on the image data and to detect the light amounts of the plurality of laser light sources, and adjust the emitting light amounts of the plurality of laser light sources based on the detected light amounts of the plurality of laser light sources.

FIG. 4 shows a procedure of detecting and setting an emitting light amount of each laser light source in such a case.

After a power is turned on and the original image data VIN is input to the control circuit 24 (S.1), the control circuit 24 judges whether or not the input original image data VIN corresponds to image data to be formed by allowing each of the laser light sources 20, 21 and 22 to separately emit the light.

Here, when the original image data VIN is input to the control circuit 24, the control circuit 24 judges whether or not the input original image data VIN is a separate red data (S.2). Here, separate color data may be data in only one color. If the input data is the separate red data, the control circuit 24 detects output from the light-receiving element 26 (S.3), and sets current of the red light source such that the light output of the laser light source 20 coincides with a predetermined light output based on the detected result of the light-receiving element 26, and then terminates the light amount setting.

In S.2, if the input original image data is not the separate red data, the control circuit 24 determines the judged result as “No” and moves the procedure to S.5. The control circuit 24 judges whether or not the input original image data is a separate green data (S.5), and if it is the separate green data, the control circuit 24 detects output from the light-receiving element 26 (S.6). The control circuit 24 sets current of the green light source output based on the detected result of the light-receiving element 26 such that the light output of the laser light source 21 coincides with a predetermined light (S.7), and then terminates the light amount setting.

In S.5, if the input original image data is not the separate green data, the control circuit 24 determines the judged result as “No” and moves the procedure to S.8. The control circuit 24 judges whether or not the input original image data is a separate blue data (S.8) and if it is the separate blue data, the control circuit 24 detects output from the light-receiving element 26 (S.9). The control circuit 24 sets current of the blue light source based on the detected result of the light-receiving element 26 such that the light output of the laser light source 22 coincides with a predetermined light output (S.10), and then terminates the light amount setting.

If the control circuit 24 determines the judged result in S.8 as “No”, the control circuit 24 returns the procedure to S.1 and detects input of a next original image data YIN and then repeats the process S.1 and the following processes.

As described above, only when any one of the laser light sources 20 to 22 separately emits the light, the control circuit 24 detects output from the light receiving element 26 and sets current value for driving the laser light source such that the detected light amount coincides with a predetermined light amount.

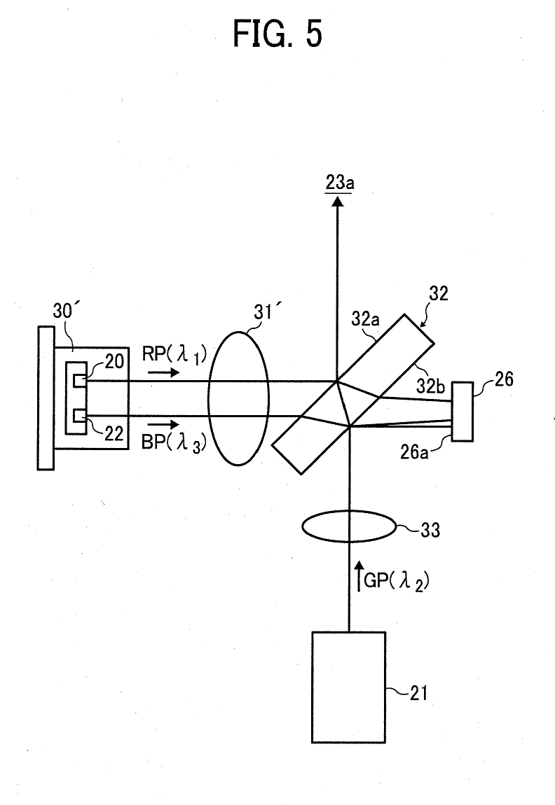

FIG. 5 is a view of an optical system showing a configuration to combine the laser lights RP, GP and BP from the laser light source 20, 21 and 22 by use of a wedge prism and to perform splitting a light path for the light receiving element by use of the wedge prism.

Here, the laser light sources 20 and 22 are housed in a same package 30′. Divergent angles of the laser light RP from the laser light source 20 and the laser light BP from the laser light source 22 are converted by a coupling lens 31′ and the laser lights RP and BP are guided to the wedge prism 32.

Dichroic films are formed on a front surface 32a and a rear surface 32b of the wedge prism 32. The dichroic film on the front surface 32a has a characteristic of reflecting a main part of the laser light RP and transmitting the other part of the laser light RP and a characteristic of totally transmitting the laser lights BP and GP.

The dichroic film on the rear surface 32b has a characteristic of totally transmitting the laser light RP, a characteristic of reflecting a main part of the laser light BP and transmitting the other part of the laser light BP, and a characteristic of transmitting a main part of the laser light GP and reflecting the other part.

A main part of the laser light RP from the laser light source 20 is reflected on the front surface 32a of the wedge prism and guided to the micro mirror 23a. The other part of the laser light RP is totally transmitted through and guided to the light receiving element 26.

The laser light BP from the laser light source 22 is totally transmitted through the front surface 32a and the main part of the laser light BP is reflected on the rear surface 32b, guided to the front surface 32a, totally transmitted again through the front surface 32a and then guided to the micro mirror 23a. The other part of the laser light BP is transmitted through the rear surface 32b and guided to the light receiving element 26.

The laser light source 21 is disposed at a symmetrical position to the package with respect to the wedge prism 32. A divergent angle of the laser light GP from the laser light source 21 is converted by the coupling lens 33 and guided to the wedge prism 32.

A main part of the laser light GP from the laser light source 21 is transmitted through the rear surface 32b, totally transmitted through the front surface 32a, and then guided to the micro mirror 23a. The other part of the laser light GP from the laser light source 21 is reflected on the rear surface 32b and guided to the light receiving element 26.

Here, according to the reflection-transmission characteristics of the wedge prism 32, for example, light amounts of light fluxes guided to the micro mirror 23a of the laser lights RP, GP and BP are 95% of the light amounts of the laser lights RP, GP and BP and light amounts of light fluxes guided to the light receiving element of the laser lights RP, GP and BP are 5% of the light amounts of the laser lights RP, GP and BP.

### EXAMPLE 2

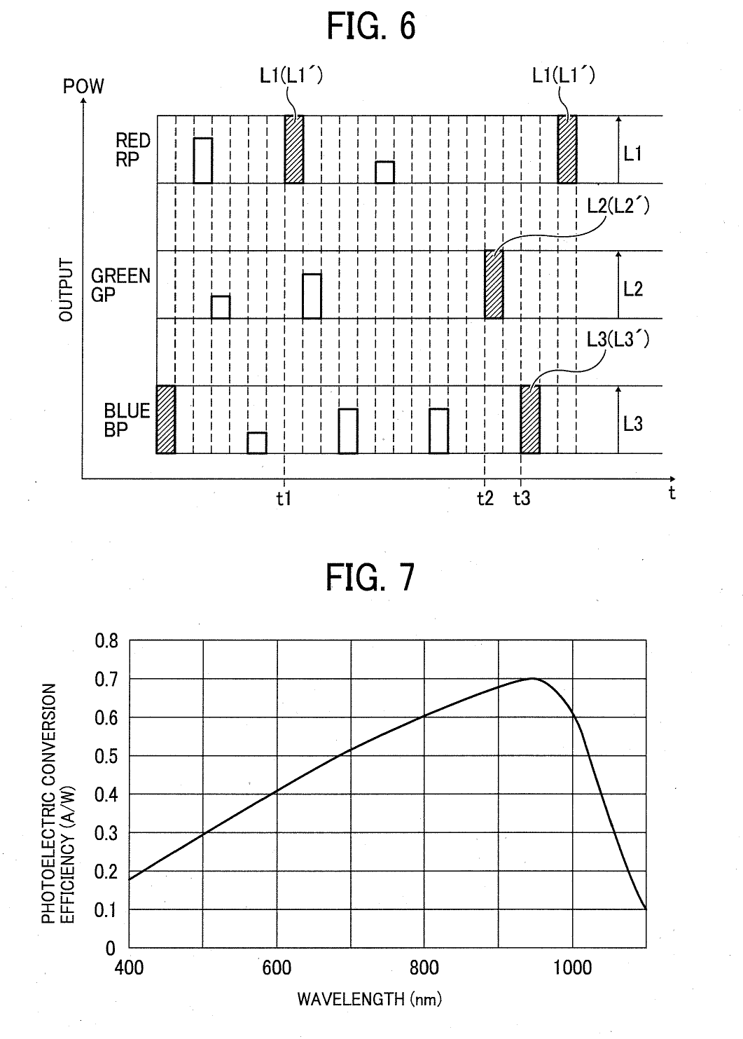

FIG. 6 is an explanatory view showing a relationship between light emitting timings of the laser light sources 20, 21 and 22 at vicinities of the coordinate points H, I, J and K of the image forming area G1 and emitting light intensities. In FIG. 6, a horizontal axis indicates time t and a vertical axis indicates an emitting light intensity POW. At the vicinities of the coordinate points H, I, J and K, as described above, if the laser light sources 20, 21 and 22 emit the laser lights at a same timing, beam spots of the laser lights RP, GP and BP are respectively formed at different pixels ge from each other on the screen.

The light emitting timings of the laser light sources 20, 21 and 22 are shifted from each other such that the beam spots of the laser lights RP, GP and BP are formed on the same pixel ge to reproduce a color of the original image data at the pixel.

It is only needed to determine the emitting light intensity POW as to closely reproduce the color of the original image when the colors are combined with each other in consideration of afterimage phenomenon of eyes. Therefore, the emitting light levels of the emitting light intensities POW of the laser light sources 20, 21 and 22 are appropriately set as a plurality of levels while considering a relationship between the light emitting timing and the emitting light intensity.

In this case, the control circuit may be configured to control the light receiving element 26 to receive the second lights at timings when the emitting light amounts of the plurality of laser light sources are at timings of maximum light amount level and to detect the received light amounts.

In order to have a large S/N (noise) ratio of the light amount received by the light receiving clement 26, emitting light amounts of the laser light sources 20, 21 and 22 are automatically controlled based on light receiving signals of the light receiving element 26, which are obtained as of points in time when the laser light sources 20, 21 and 22 have maximum emitting light levels L1, L2 and L3, respectively. Thereby, an accuracy of an APC can be improved.

For example, the light receiving level L1′ corresponding to the maximum emitting light level L1 of the maximum emitting light intensity POW of the laser light source 20 at a timing t1 of the coordinate point G1 of the image forming area G1 is to be obtained by the light receiving element. However, if the light receiving level obtained by the light receiving element 26 is a light receiving level of (γ/100)×L1′, which is decreased by γ % in relation to the light receiving level L1′, the emitting light intensity POW of the laser light source 20 is automatically controlled within one image forming range from the coordinate point H to the coordinate point K based on the decrease in the light receiving level.

With respect to the other laser light sources 21 and 22, the laser light sources 21 and 22 are automatically controlled based on the light receiving level L2′ and L3′ obtained corresponding to the maximum emitting light levels L2 and L3 of the laser light sources 21 and 22 at timings t2 and t3, respectively.

### EXAMPLE 3

FIG. 7 shows a photoelectric conversion efficiency of the light receiving element 26 in relation to a wavelength. The photoelectric conversion efficiency is shown by a curve which functionally changes, as shown in FIG. 7, in relation to the wavelength. The photoelectric conversion efficiencies are, 0.45, 0.33, and 0.23 (A/W) with respect to the red light RP of the wavelength λ1=640 (nm), the green light (GP) of the wavelength λ2=530 (nm) and the blue light (BP) of the wavelength λ3=445 (nm), respectively.

Accordingly, if it is supposed that the light receiving element 26 receives same light amounts of the lights of the wavelengths λ1, λ2 and λ3 each other, output currents of the light receiving element 26 are in a proportion of red:green:blue=4:3:2. That is, when the light receiving element receives the red light, the received current which is twice the blue light is output.

In the second embodiment, at the light emitting timings t1, t2 and t3, the maximum emitting light levels L1, L2 and L3 of the laser light sources 20, 21 and 22, the light receiving element 26 receives the laser lights of the laser light sources 20, 21 and 22 to perform APC controls, respectively.

Therefore, by providing a gain switching device configured to switch a gain at timings of receiving the laser lights RP, GP and BP between the control circuit 24 and the light receiving element 26, it is necessary to control the apparatus such that the received light currents from the light receiving element 26, which are fed back to the control circuit 24, have the same level, even when the received light current outputs from the light receiving element 26 at the light emitting timings of the maximum emitting light levels L1, L2 and L3 of the laser light sources 20, 21 and 22 which emit the lights at different timings from each other are changed depending on the photoelectric conversion efficiencies in the received light currents.

However, when the gain switching device is provided in the circuit, the circuit becomes complex in general.

Then, in order to simplify the circuit configuration, the following improvement may be made.

That is, when the laser lights RP, GP and BP of the wavelengths λ1, λ2 and λ3 are detected by the light receiving element 26, as the difference between values of currents output from the light receiving element 26 is decreased, the emitting light amount levels of the laser light sources 20, 21 and 22 received by the light receiving element 26 is selected.

For example, when the light amounts entering the light receiving element 26 for the wavelengths λ1, λ2 and λ3, are P1, P2 and P3, it the light amounts P1, P2 and P3 entering the light receiving element 26 are set such that the following relationship is obtained:

P1<P2<P3 (1),

the values of the received light currents of the light receiving element 26 may be closed to each other

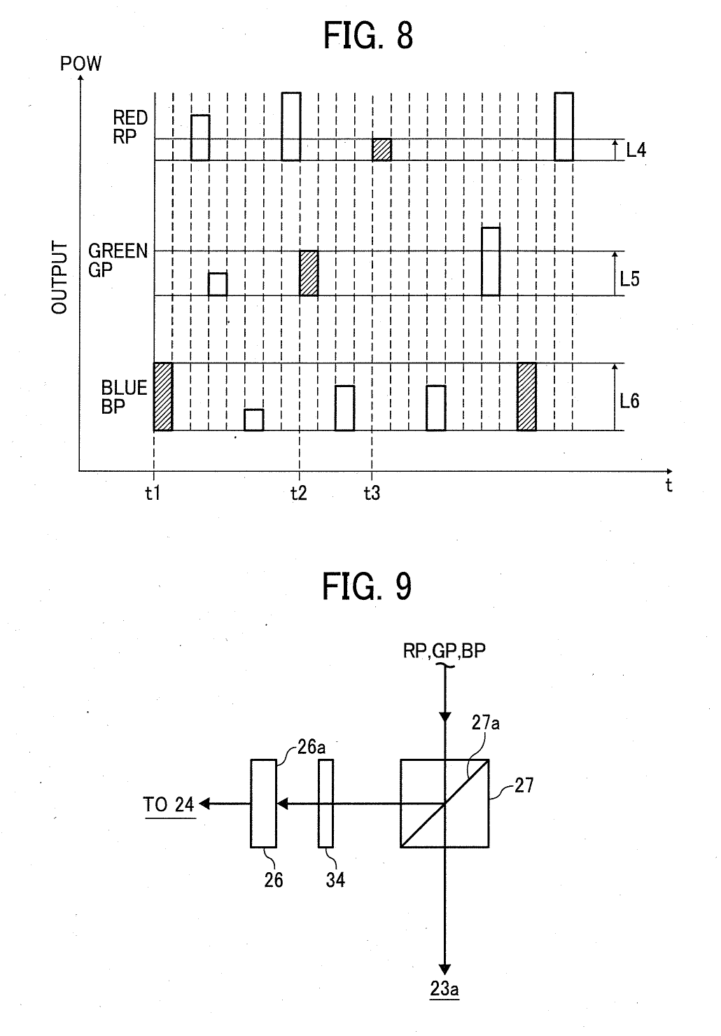

FIG. 8 shows light emitting timings of the laser light sources 20, 21 and 22 of the lights RP (red light), GP (green light) and BP (blue light), an edge part of the image G same as the image of FIG. 6, that is, in vicinities of the coordinate point J. Considered in the emitting light levels of the laser light sources 20, 21 and 22, in order to satisfy the condition of equation (1), the emitting light amounts of the laser lights of the wavelengths λ1, λ2 and λ3 are detected by the light receiving element 26 when the emitting light levels L4, L5 and LB (L4<L5<L6) of the red light, the green light and the blue light (when emitting the light shown by shadowed part in FIG. 8).

Ideally, if the relationship is P1:P2:P3=2:3:4, when the three color laser lights of the wavelengths λ1, λ2 and λ3 are detected by the light receiving element 26, the values of the received light current output from the light receiving element 26 are substantially same each other. FIG. 8 shows a case of L4:L5:L6=2:3:4.

### EXAMPLE 4

Although in Example 3, the light emitting timings are selected such that the emitting light levels L4, L5 and L6 of the laser light sources 20, 21 and 22 received by the light receiving element 26 are different from each other and the values of the received light currents of the laser lights RP, GP and BP, which are output from the light receiving element 26, are set to be same each other, the optical system can be configured such that the light emitting timings shown in FIG. 6 in which the emitting light levels L1, L2 and L4 of the laser light sources 20, 21 and 22 received by the light receiving element 26 are same each other are selected and the values of the received light currents of the laser lights RP, GP and BP output from the light receiving element 26 are same each other.

For example, as shown in FIG. 9, a dichroic filter 34 is disposed between the light flux splitting element 27 and the light receiving element 26.

When transmission efficiencies are indicated by T1, T2 and T3, for the wavelengths λ1=640 (nm), λ2=530 (nm), and λ3=445 (nm), respectively, if the dichroic filter 34 is formed so as to have a transmission property in that the transmission efficiencies for the wavelengths λ1, λ2 and λ3 have a relationship of T1<T2<T3, the following condition can be satisfied:

Q1<Q2<Q3 (2)

where Q1, Q2 and Q3 indicates received light amounts of the laser lights RP, GP, and BP entering the light receiving element 26. As a result, the values of the received light currents of the light receiving element 26 for each colors can be brought close to each other. If the transmission efficiencies are set as T1:T2:T3=2:3:4, the received light amounts can be set as Q1:Q2:Q3=2:3:4.

Moreover, a wedge optical element having different refractive characteristics due to wavelength change may be disposed between the light path splitting device and the light receiving element, the dichroic filter having an optical characteristic in which the following relationship is satisfied:

Q1<Q2<Q3 (2)

where the wavelengths of the plurality of laser light sources are λ1, λ2 and λ3 (λ1>λ2>λ3) and the light amounts received by the light receiving element for the wavelengths λ1, λ2 and λ3 in a case where the emitting light intensities of the laser light sources are same each other, are Q1, Q2 and Q3, respectively.

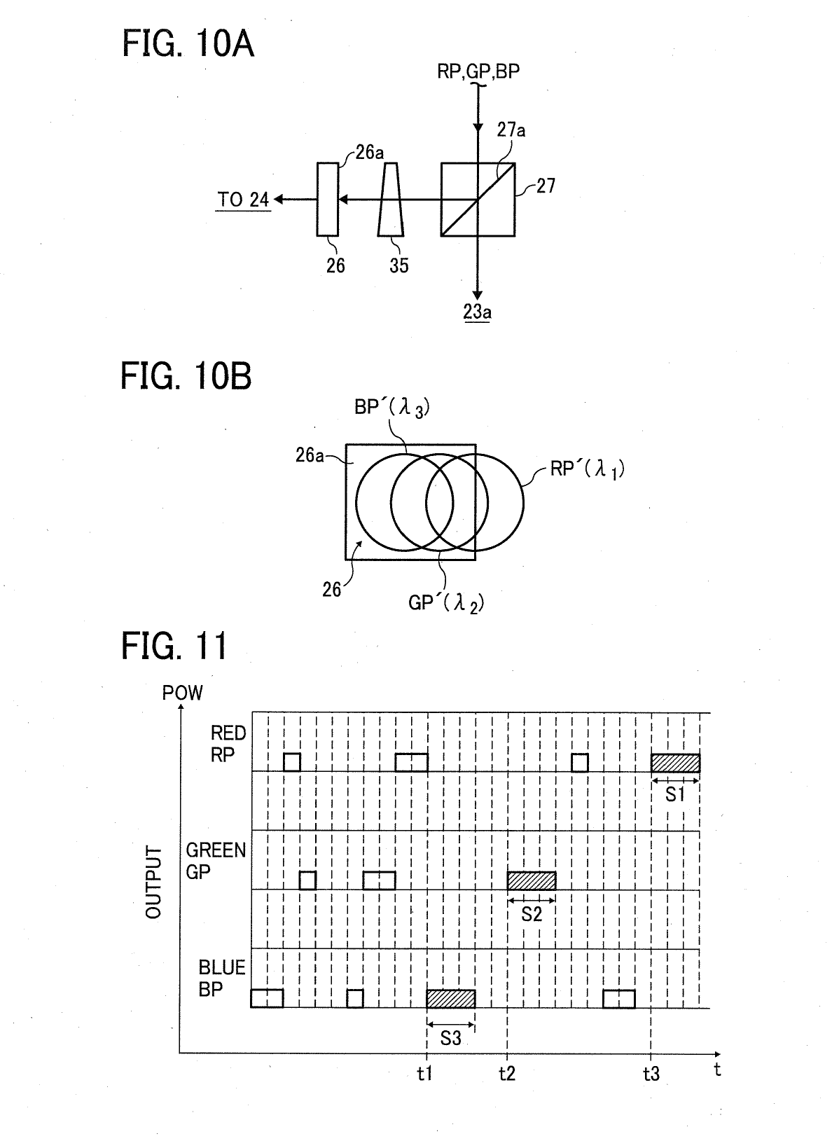

For example, a wedge optical element (wedge prism) 35 having refraction property depending on the wavelength and disposed between the light flux splitting element 27 and the light receiving element 26 is disposed as shown in FIG. 10A.

Beam spots RP′, GP′ and BP′ for monitoring (see FIG. 10B) may be formed by the laser lights reflected on the light flux splitting element 27 and entering a receiving surface 26a of the light receiving element 26. Of the monitoring beam spots RP′, GP′ and BP′, if the optical system is configured such that a half of the monitoring beam spot RP′ of the wavelength λ1 is received on the light receiving surface 26a, the other half is not received on the light receiving surface 26a, a half or more of the monitoring beam spot GP′ of the wavelength λ2 is received on the light receiving surface 26a except for a part, the part is not received on the light receiving surface 26a, and all of the monitoring beam spot BP′ of the wavelength λ3 is received on the light receiving surface, the light amounts of the laser lights RP, GP and BP entering the light receiving element 26 can be set similarly as

Q1<Q2<Q3 (2).

As a result, the values of received light currents of the light receiving element 26 for each color can be brought close to each other. In this case, if the optical system is configured such that light receiving areas of the monitoring beam spots RP′, GP′ and EP′ on the light receiving surface 26a are set as 2:3:4, the received light amounts are set as Q1:Q2:Q3=2:3:4.

### EXAMPLE 5

In Examples 2 and 3, based on the emitting light intensities POW of the laser light sources 20, 21 and 22, the case is explained in that the color of the one pixel ge is reproduced. However, there is a method for reproducing the color by use of time differences in light emitting time of the laser light sources 20, 21 and 22.

The control circuit may be configured to control the light receiving element to receive the second lights to detect the light amounts when a light emitting time width of the laser light source is a predetermined width or more.

FIG. 11 shows a light emitting pattern for reproducing a color in one pixel ge at a vicinity of the coordinate point J within the image forming area G1 by use of the time differences in the light emitting time of the laser light sources 20, 21 and 22.

A vertical axis indicate time t, a horizontal axis indicates the emitting light levels POW of the laser light sources 20, 21 and 22. In this Example shown in FIG. 11, by equalizing the emitting light levels POW of the laser light sources 20, 21 and 22 and changing light emitting timings and light emitting time widths of the laser light sources 20, 21 and 22, the color on the one pixel ge can be reproduced.

That is, a plurality of light emitting time width different from each other are selected and determined such that a desired color is reproduced when the laser lights RP, GP and BP are combined according to the color of the original image.

In this case, if the emitting light amounts of the laser lights RP, GP and BP are detected by the light receiving element at light emitting timings of widest time widths S1, S2 and S3 of the light emitting time widths of the red, green and blue laser lights RP, GP and BP, respectively, a fast detection circuit is not required to detect an emitting light amount so that accuracy of the APC can be improved.

### EXAMPLE 6

The control circuit may be configured to control the light receiving element to receive the second lights to detect the light amounts when an emitting light intensity of the laser light source is a predetermined value or more and a light emitting time width of the laser light is a predetermined width or more.

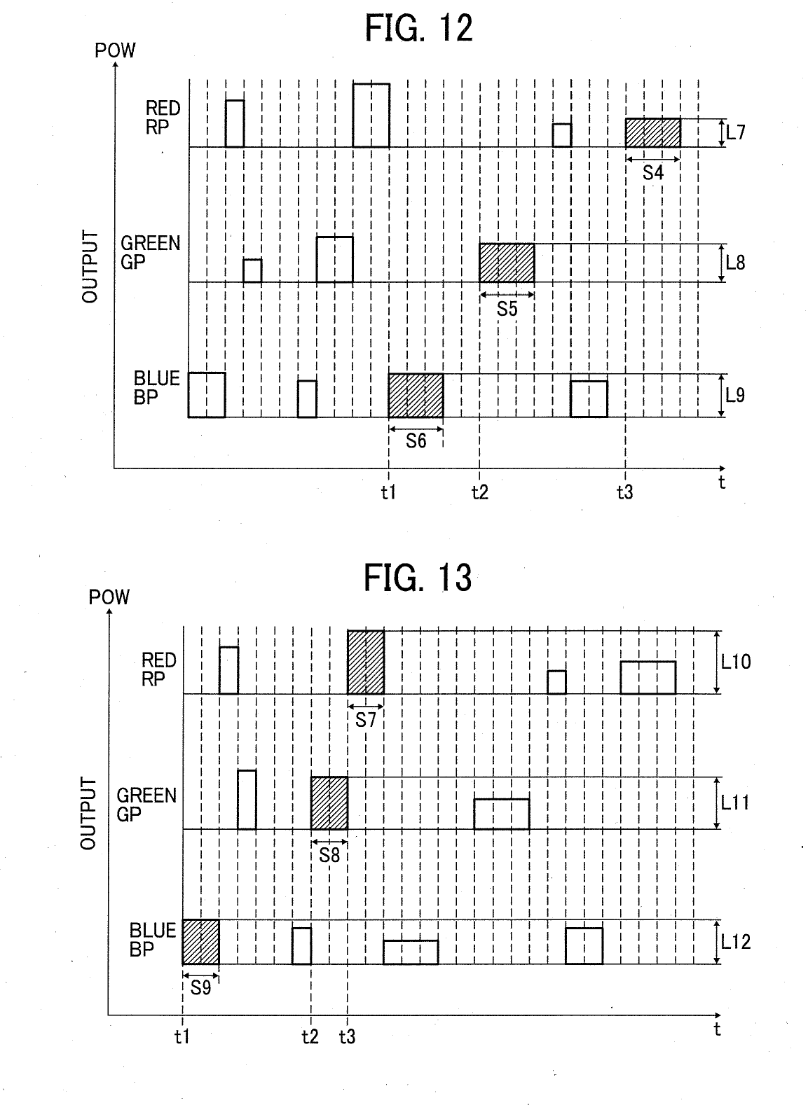

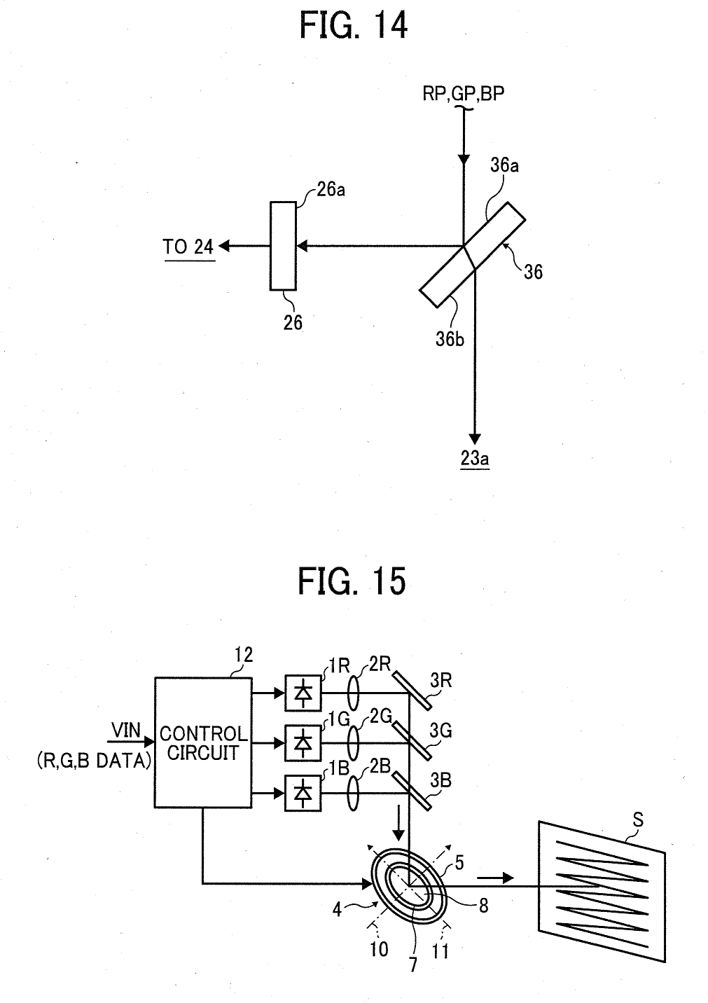

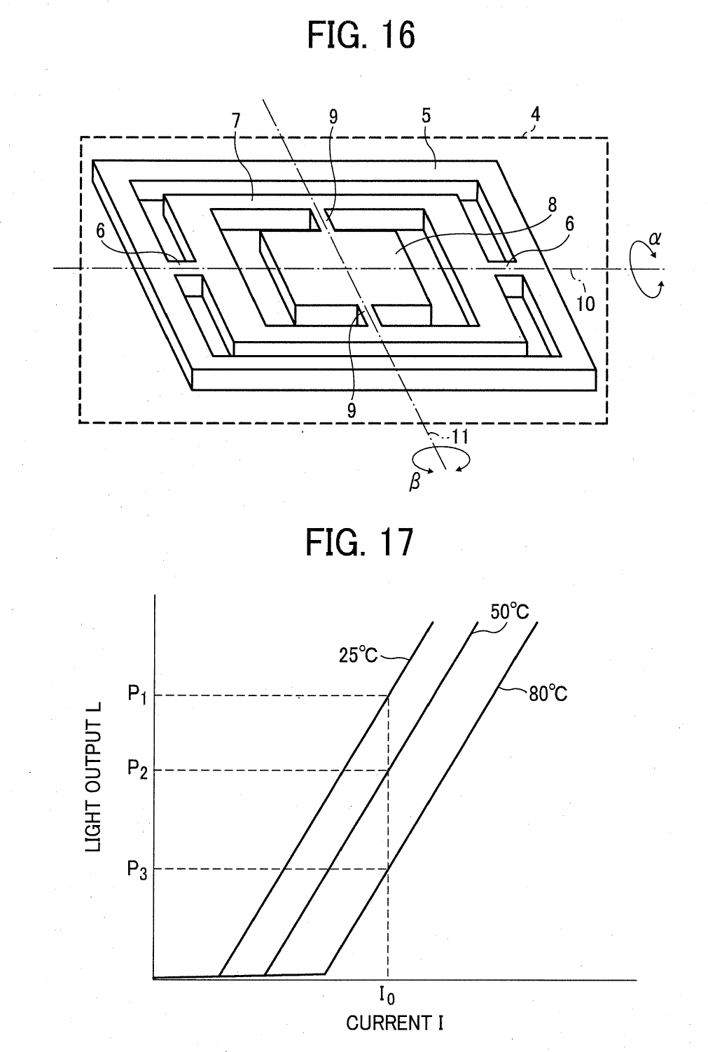

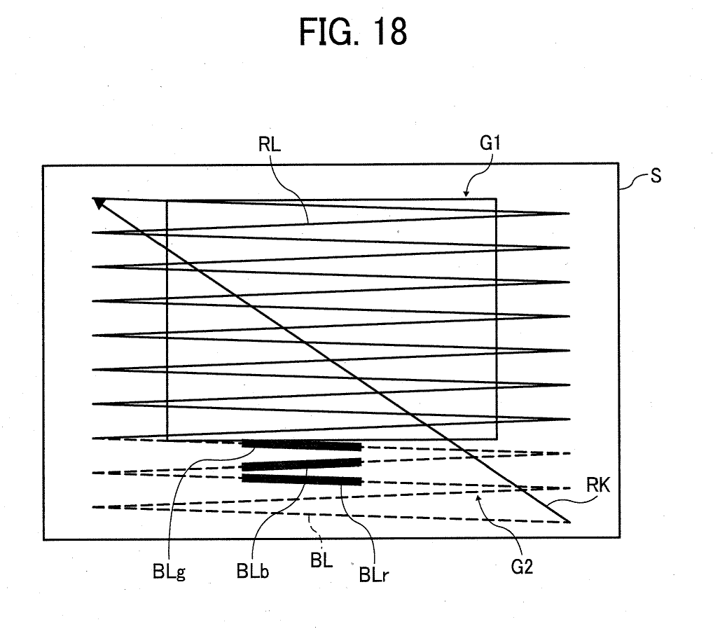

FIG. 12 is an explanatory view showing light amount detection timings of the light receiving element 26 in a case where a desired color can be reproduced when the laser lights RP, GP and BP are combined, by combining difference in the light emitting times of the laser light sources 20, 21 and 22 and difference in the emitting light intensities of the laser light sources 20, 21 and 22.

In FIG. 12, the APC is performed by monitoring the light emitting amounts of the laser light sources 20, 21 and 22 at light emitting timings when the emitting light intensities of the laser light sources 20, 21 and 22 are a predetermined value L7 or more, L7<L8<L9 and the light emitting time widths S4, S5 and S6 are a predetermined time width or more.

FIG. 13 shows the APC is performed by monitoring the emitting light amounts of the laser light sources 20, 21 and 22 at light emitting timings when the emitting light intensities L10, L11 and L12 of the laser light sources 20, 21 and 22 are a predetermined level or more and the light emitting time widths S7, S8 and S9 are predetermined time or more.

### EXAMPLE 7

The light path splitting element may be a flat plate which is transparent to the wavelength of each of the laser lights of the plurality of laser light sources.

FIG. 14 shows an optical system in which glass or plastic flat plate 36 is used as the light path splitting prism 27. If a surface 36a of the flat plate 36 is not coated, a surface reflection due to difference in refractive indices between glass or plastic and air occurs and light fluxes can be split. If the refractive index is 1.5, the surface reflection of about 4% occurs, In a case of the flat plate 36, since the surface reflection occurs at two surfaces of the front surface 36a and the rear surface 36b, light of about 8% is reflected and split.

If the monitoring light amount of about 4% is sufficient, a reflection preventing coating may be provided at one surface of the front surface 36a and the rear surface 36b. Moreover, in a case where the beam is parallel light, if a parallel plate is used as the flat plate, aberration in the beam can be suppressed. In a case where the beam is a convergent light or a divergence light, an appropriate wedge shape plate may be used to reduce occurrence of astigmatism.

By using the flat plate 36 formed from glass or plastic, a lower-cost production can be achieved than cubic prism on which light flux splitting film such as dielectric multilayer or the like is formed.

According to an embodiment of the present invention, since the light amount detection at timings of performing the APC operation is performed within the image forming area, the unnecessary non-image forming area which does not contributes to formation of the image for light amount detection is not required and therefore the APC operation can be performed while keeping the image in a brightest state.

According to an embodiment of the present invention, the light amounts are sequentially detected at a timing when one of a plurality of laser light sources emits singularly light. Accordingly, increase of component number and then increase of cost can be suppressed. In addition, difference in a control signal level due to difference in sensitivity of the light receiving element for lights of a plurality of wavelengths is suppressed so that the APC of the plurality of light sources can be achieved by a simple control circuit.

According to an embodiment of the present invention, since, at the timing where the emitting light intensity of the plurality of laser light sources are respectively in the maximum light amount levels, the received light amounts of the lights entering the light receiving element are detected, signals having large S/N ratio can be obtained so that accuracy of the APC can be improved.

According to an embodiment of the present invention, the emitting light intensities of the plurality of laser light sources are selected so as to satisfy the relationship of P1<P2<P3 where P1, P2 and P3 are received light amounts of the lights received by the light receiving element for wavelengths λ1, λ2 and λ3 (λ1>λ2>λ3) of the plurality of laser light sources, respectively. Accordingly, according to sensitivity to the wavelength of the light receiving element, difference in the output current values can be reduced and the APC operation can be achieved by a simple detection circuit while it is not necessary to have a large dynamic range of the detection circuit or to change a gain.

According to an embodiment of the present invention, the optical system is designed such that Q1<Q2<Q3, where Q1, Q2 and Q3 are respectively received light amounts of the lights received by the light receiving element when emitting light intensities of the laser light sources are same each other for the wavelengths λ1, λ2 and λ3 (λ1>λ2>λ3) of the laser light sources. Therefore, according to sensitivity to the wavelength of the light receiving element, difference in output current values can be reduced, signals having a large SIN ratio can be obtained and therefore accuracy of the APC can be improved.

Furthermore, the APC operation can be performed by a simple detection circuit while it is not necessary to have a large dynamic range of the detection circuit or to change a gain.

According to an embodiment of the present invention, the light emitting amounts of the laser lights of wavelengths are respectively detected by the light receiving element at the timing of wide light emitting time of the laser light sources. Therefore, fast detection circuit is not required and maximum light amount levels of the emitting light intensities can be detected so that accuracy of the APC can be improved.

According to an embodiment of the present invention, by combination of the above features, above described advantageous effects according to the above features can be achieved.

According to an embodiment of the present invention, a monitoring light can be split due to a surface reflection of, for example, a parallel flat plate of glass as a light flux split element. Therefore, variation of reflection ratio due to environment change can be reduced and stable light amount control system can be provided. Furthermore, even if a specific coating is not provided, reflected light can be obtained and cost reduction can be achieved.

Although the present invention has been described in terms of exemplary embodiments, it is not limited thereto. It should be appreciated that variations may be made in the embodiments described by persons skilled in the art without departing from the scope of the present invention as defined by the following claims.

What is claimed is:

1. A projection-type image display apparatus for displaying an image on a projected plane, comprising:
a plurality of laser light sources each configured to emit a laser light;
a light-path combining element configured to combine light paths of the laser lights each emitted from the plurality of laser light sources;
a light path splitting element configured to split the combined light path into first and second light paths, each of the laser lights being split into a first light passing the first light path and a second light passing the second light path;
a scanning mirror configured to reflect the first lights of the laser lights to scan the projected plane with the first lights of the laser lights;
a light receiving element configured to receive the second lights of the laser lights to detect light amounts of the received second lights; and
a control circuit configured to control the scanning mirror to scan an image forming area of the projected plane with the first lights of the laser lights based on image data and control the plurality of laser light sources so as to reproduce a color based on the image data,
wherein the control circuit is configured to
control the light receiving element to detect the light amounts of the plurality of laser light sources when the image forming area is scanned with the first light, and
adjust emitting light amounts of the plurality of laser light sources based on the detected light amounts of the plurality of laser light sources.

2. The projection-type image displaying apparatus according to claim 1, wherein the control circuit is configured to
control the light receiving element
to receive the second lights sequentially at timings when only one of the plurality of laser light sources emits the light based on the image data and
to detect the light amounts of the plurality of laser light sources; and
adjust the emitting light amounts of the plurality of laser light sources based on the detected light amounts of the plurality of laser light sources.

3. The projection-type image displaying apparatus according to claim 1, wherein the control circuit is configured to control the light receiving element to receive the second lights at timings when the emitting light amounts of the plurality of laser light sources are at timings of maximum light amount level and to detect the received light amounts.

4. The projection-type image displaying apparatus according to claim 1, wherein the light amount level of emitting light intensity of each of the plurality of laser light sources is selected such that the following relationship is satisfied:
P1<P2<P3 (1)
where the wavelengths of the plurality of laser light sources are λ1, λ2 and λ3 (λ1>λ2>λ3) and the light amounts received by the light receiving element for the wavelengths λ1, λ2 and λ3 are P1, P2 and P3, respectively.

5. The projection-type image displaying apparatus according to claim 1, wherein a dichroic filter is disposed between the light path splitting device and the light receiving element, the dichroic filter having an optical characteristic in which the following relationship is satisfied:
Q1<Q2<Q3 (2)
where the wavelengths of the plurality of laser light sources are λ1, λ2 and λ3 (λ1>λ2>λ3) and the light amounts received by the light receiving element for the wavelengths λ1, λ2 and λ3 in a case where the emitting light intensities of the laser light sources are same each other, are Q1, Q2 and Q3, respectively.

6. The projection-type image displaying apparatus according to claim 1, wherein a wedge optical element having different refractive characteristics due to wavelength change is disposed between the light path splitting device and the light receiving element, the dichroic filter having an optical characteristic in which the following relationship is satisfied:
Q1<Q2<Q3 (2)
where the wavelengths of the plurality of laser light sources are λ1, λ2 and λ3 (λ1>λ2>λ3) and the light amounts received by the light receiving element for the wavelengths λ1, λ2 and λ3 in a case where the emitting light intensities of the laser light sources are same each other, are Q1, Q2 and Q3, respectively.

7. The projection-type image displaying apparatus according to claim 1, wherein the control circuit is configured to control the light receiving element to receive the second lights to detect the light amounts when a light emitting time width of the laser light source is a predetermined width or more.

8. The projection-type image displaying apparatus according to claim 4, wherein the control circuit is configured to control the light receiving element to receive the second lights to detect the light amounts when an emitting light intensity of the laser light source is a predetermined value or more and a light emitting time width of the laser light is a predetermined width or more.

9. The projection-type image displaying apparatus according to claim 1, wherein the light path splitting element is a flat plate which is transparent to the wavelength of each of the laser lights of the plurality of laser light sources.
